(19) United States
(12) Patent Application Publication
(10) Pub. No.: US 2007/0112657 A1
(43) Pub. Date: May 17, 2007

(54) Exchange Traded Fund or the Like Related to Basket of Fixed Income Securities Having Similar Maturities

(76) Inventor: John M. Huber, St. Louis Park, MN (US)

Correspondence Address: Peter F. Weinberg;Gibson, Dunn & Crutcher LLP, Suite 4200, 1801 California Street, Denver, CO, 80202, US

(21) Appl. No.: 11/538,395

(22) Filed: Oct. 3, 2006

Related U.S. Application Data
(60) Provisional application No. 60/723,248, filed on Oct. 3, 2005.

(51) Int. Cl. G06Q 40/00

(52) U.S. Cl. 705/35

(57) ABSTRACT

An exchange traded fund (ETF) is composed of a basket of fixed income securities. The fixed income securities have maturity dates within a relatively narrow range from a predefined range of each other (e.g., within approximately from five years from the launch of the ETF). The ETF pays interest to its owners. After the maturity dates, the ETF pays the principal to its owners and ceases operation. The ETF therefore has performance characteristics similar to an individual bond while having the diversification benefits of a traditional ETF or other fund.

### CROSS REFERENCE TO RELATED APPLICATION

The present patent application is related to and claims the benefit of priority from U.S. Provisional Patent Application No. 60/723,248 having a filing date of Oct. 3, 2005, which is hereby incorporated by reference in its entirety.

### FIELD OF THE INVENTION

The present invention relates to the field of investment securities. More particularly, the invention relates to an exchange traded fund composed of fixed income securities that have the same maturity within a defined range and that mature on the same date within a defined range, and where the fund pays the principal to its owners upon maturity and ceases operation.

### BACKGROUND OF EXCHANGE TRADED FUNDS (ETFs)

Exchange Traded Funds (ETFs) are baskets of securities (stocks and bonds) and have proven to be both cost effective and convenient for institutional and retail investors. Each share of the ETF represents ownership in the underlying basket of stocks/bonds designed to closely track a specific index or benchmark. ETFs trade throughout the day as ordinary stocks on stock exchanges, allowing investors to use the same strategies used with other equity investments, such as market and limit orders, buying on margin, short selling, and consolidated broker reporting.

ETFs encompass a wide variety of asset classes, including domestic and international indexes and bond indices. ETF offerings are equity dominated with few fixed income options. Fixed income ETFs have historically been closed end funds. ETFs have been a growing investment vehicle, as shown by growing analyst coverage, media coverage, distribution (retail penetration and institutional hedging and arbitrage, with a growth of specialists), and global expansion. ETFs have a number of advantages over traditional mutual funds. They are highly tradable, having intraday execution, liquidity, and exchange for components. They are low cost and tax efficient. They are fully transparent. ETFs appeal to both retail customers and institutional entities that may either buy or sponsor or otherwise offer services related to ETFs.

General ETF Structures

ETFs must be filed with Securities and Exchange Commission. The process to take an ETF to market may be on the order of one year. The key participants in managing and issuing ETFs are as follows:

Index Creator/Licensor (e.g., Dow Jones, etc.)—Using a reference Swap Rate/Treasury rate or relevant index

ETF Sponsor

Fund Distributor/Distribution Network

ETF Services—Accounting, Custody and Administration

Investment Manager

Transfer Agent

DTC/NSCC-Basket Dissemination & Creation Process

Audit/Legal

Specialist and/or Market makers.

ETFs may follow three legal structures. Below is a brief summary of each. The first two structures may be preferable with respect to the invention. Of course, the invention encompasses other legal structures as they may come into being.

Exchange Traded Fund—Open-End Index Fund This type of fund structure reinvests dividends on the date of receipt and pays them out via a quarterly cash distribution. This ETF structure is also permitted to use derivatives and loan securities, and is registered under the SEC Investment Company Act of 1940.

Exchange Traded Fund—Unit Investment Trust

This type of fund structure does not reinvest dividends in the fund and pays them out via a quarterly cash distribution. In order to comply with diversification rules, this ETF structure will sometimes deviate from the exact composition of a benchmark index. This type of fund is registered under the SEC Investment Company Act of 1940.

Exchange Traded Fund—Grantor Trust

This type of fund structure distributes dividends directly to shareholders and allows investors to retain their voting rights on the underlying securities within the fund. The original fund components of the index remain fixed and this ETF structure is not registered under the SEC Investment Company Act of 1940.

### DETAILED DESCRIPTION OF THE INVENTION

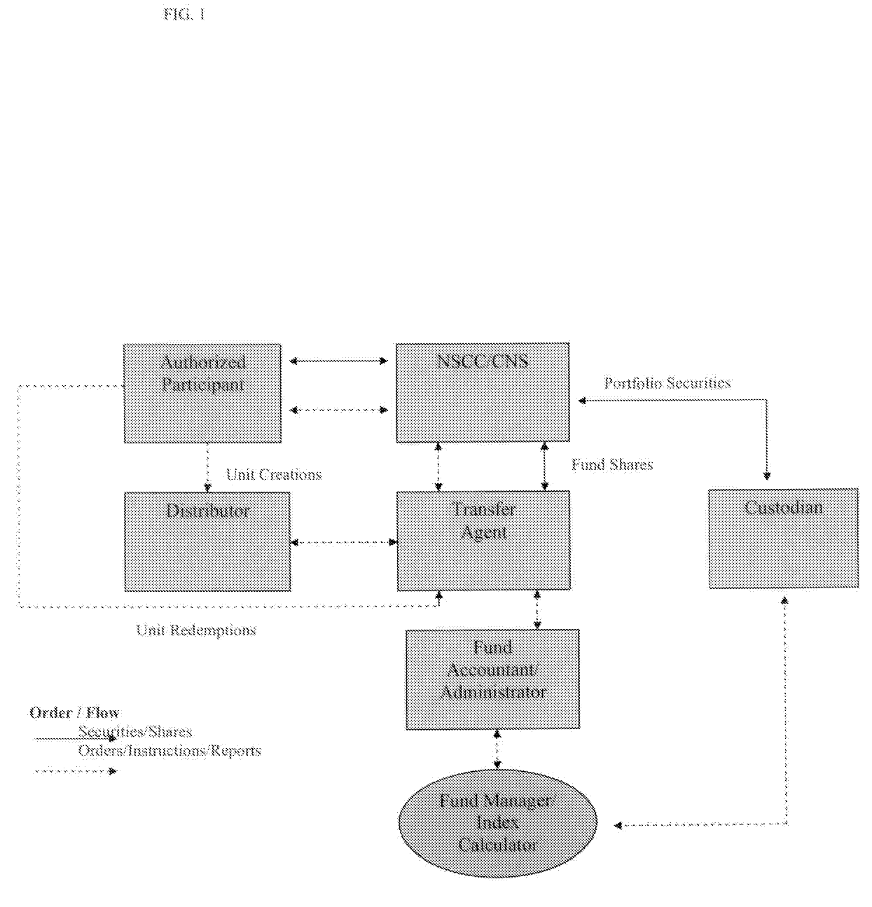

The attached FIG. 1 shows a schematic of the order and flow of an ETF according to the invention.

An object of the invention is to provide investors with an asset that blends the diversification, income and liquidity characteristics of fixed income mutual funds with the maturity and cash flow characteristics of an individual bond. In contrast, while alternatives in the fixed income ETF market offer investors funds to match index performance of limited market sectors, they provide no exit strategies in managing the risk that comes as desired liquidity dates approach.

The invention offers targeted and specific maturity dates to investors. In other words, and as explained in greater detail below, an ETF according to the invention has these primary characteristics: (1) all of the securities in the ETF are for the same maturity (within a defined range), (2) the securities mature on the same date (within a defined range), and (3) after the securities mature, the ETF pays the value to its owners and, in effect, ceases operation.

An ETF according to the invention has the following benefits:

A plan to match investments to liquidity needs;

Roll down the yield curve (e.g., 5yr becomes a 4yr);

Stable values as maturity dates approach;

Defined maturities of predefined time periods, e.g., from three to thirty years. The ETF according to the invention will mature at the end of the predefined time period and go-away (i.e., principal is paid to owners of ETF shares). This is distinct from known ETFs composed of fixed income securities maturing across several years, where the fund manages versus the constant maturity/duration target of the specified index. (i.e. Lehman Aggregate).

The present invention includes alternative strategies to realize an ETF of fixed income funds having targeted maturity dates First, the invention may employ what is termed a core strategy, which is a portfolio of fixed-rate coupon bonds maturing within the targeted period. Second, the invention may employ what is termed an overlay strategy, which is a floating-rate bond portfolio and an interest rate swap referenced to the specific maturity date of the ETF.

An advantage of the invention is that it is expected to enhance returns while reducing risk. The invention is a superior alternative to single fixed income investments or pooled/managed accounts as it allows one to invest in a single security, with appropriate diversification and a known maturity date.

Core Strategy

The core strategy of the invention has the following attributes:

Income Enhancement via strategic utilization of non-treasury sectors (Agency/Corps/ABS/MB S/Swaps)

Diversification benefits by Issuer/Issue/Sector

Traditional ETFs limited to specific areas of fixed income market—(Treasuries/TIPs or Corporates)

Portfolio turnover limited to risk reduction/income enhancement activity.

The core strategy may include the following rules:

Calendar year-end maturity dates (or maturing dates at other pre-selected times);

Fund investments mature in the calendar year (again, or other time) leading up to maturity of the fund;

Fund's effective duration maintained within a defined time, such 0.5 years, of fund's stated benchmark duration;

All investments are investment grade rated;

Underlying bond maturities reinvested in 2a7 eligible vehicle until December 30 (or other preselected) maturity;

Interest rate swaps and futures are permitted;

No speculative leverage employed;

Ongoing issuance of new ETFs according to present invention to create effective term structure and liquidity.

Additional core product strategy attributes are as follows:

Emphasize a high quality, diversified group of securities to provide additional income versus U.S. Treasury securities;

ETFs of the present invention mature on December 30 of Serial Year (or other preselected dates) (e.g. December 30 of 2007, 2008, 2010, 2012, 2015);

All Cash Flows/Interest Payments (net of fees) distributed to Shareholders — Just like owning an individual bond;

Capital Gains minimized via maturity of underlying bonds and low portfolio turnover;

Benchmark—Specific U.S. Treasury/Swap maturing on or close to serial ETF according to the invention maturity. A Targeted Maturity Index is another alternative.

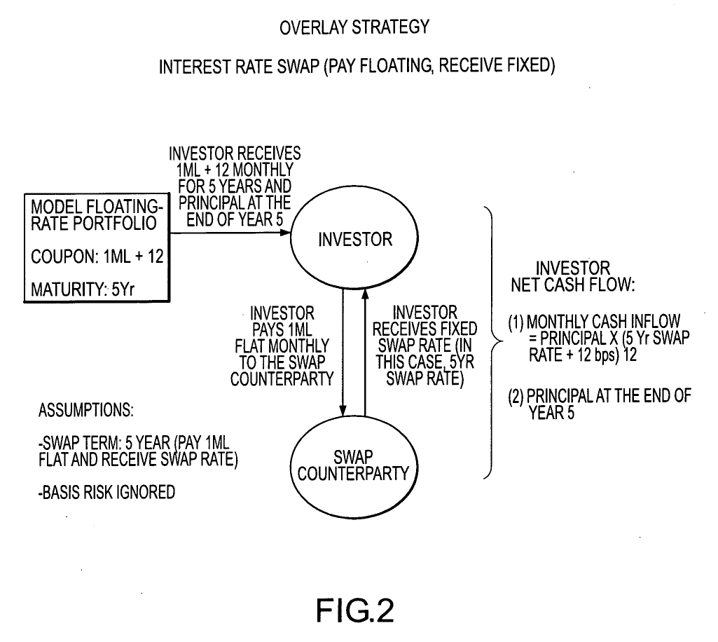

The overlay strategy of the invention is shown in exemplary form in FIG. 2, and is summarized as follows.

Swaps market simplifies B/D share creation process.

An ETF according to the present invention will mature on December 30 of Serial Year (e.g. 2007, 2008, 2010, 2012, 2015) just like core strategy.

All Cash Flows/Interest Payments (net of fees) distributed to shareholders.

Capital Gains issues eliminated due to use of par priced floating rate assets swapped to fixed.

Benchmark—specific swap rate maturing on the ETF's maturity.

Counterparty risk minimized through diversified exposure to different swap counterparties.

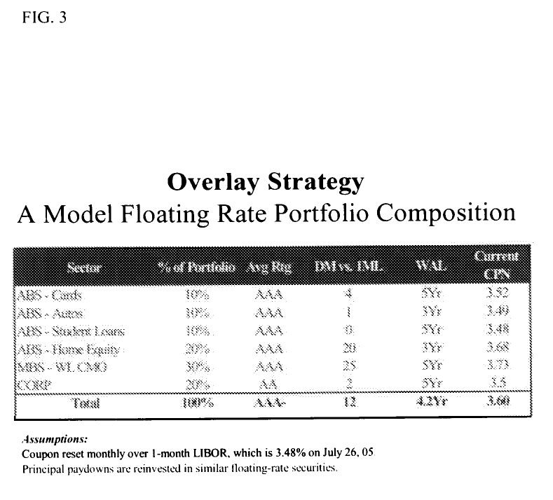

A model overlay ETF portfolio is shown in FIG. 3.

An ETF according to the advantage has the following advantages:

Reliable Tracking—ETF is marked to market daily via NAV calculation

Strong Liquidity—intraday pricing is achievable through the fund's high correlation to movements in the interest rate swap market.

Ultimate Transparency—ETF can be linked to live prices via Bloomberg or other news services and by internal (or other) analytic systems.

An ETF according to the invention offers hedging option, such as the following:

Utilize Interest Rate Swaps as primary hedging tool.

Utilize Interest Rate Futures as secondary hedging tool.

Utilize CDS or Indices as alternative hedging tool.

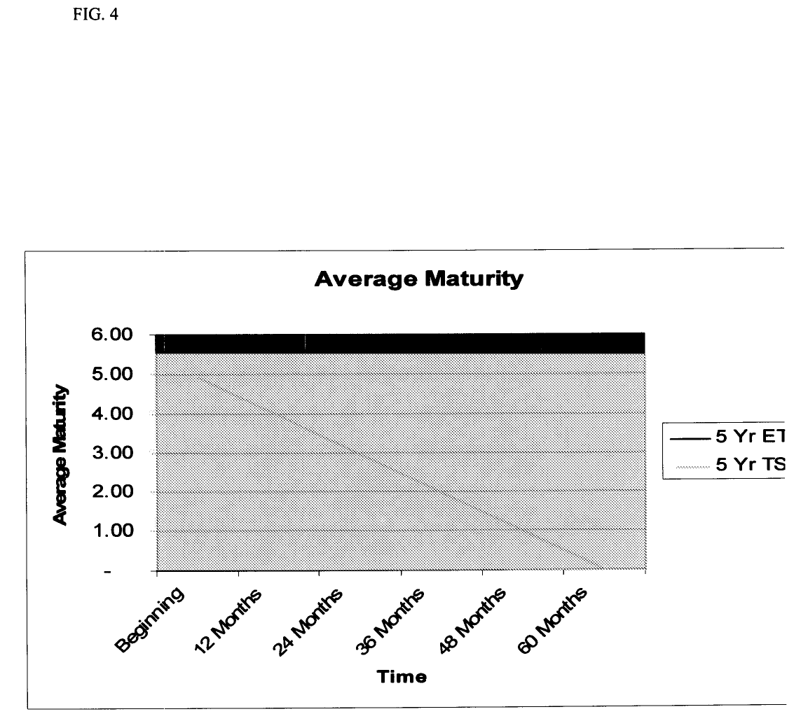

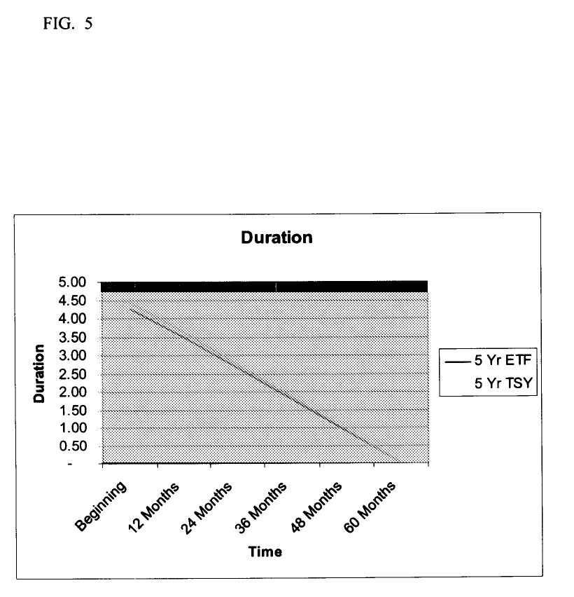

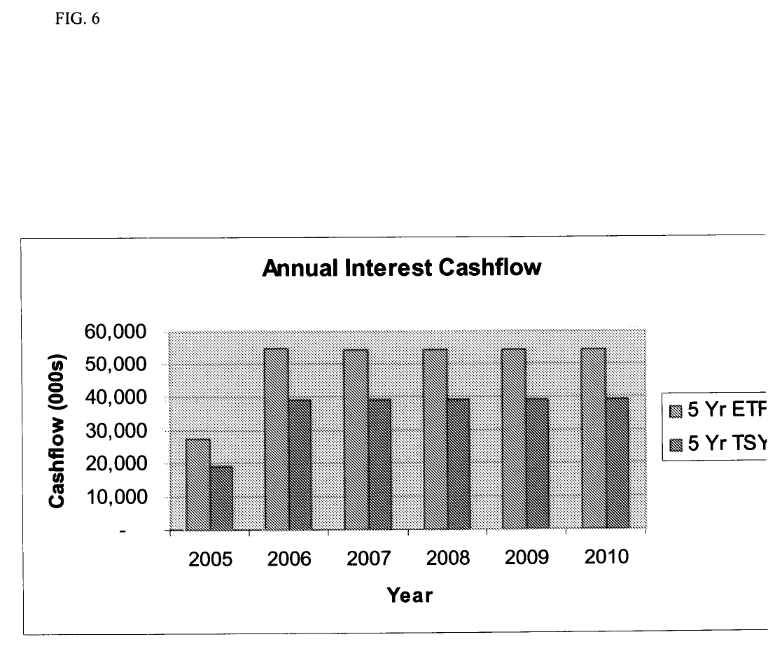

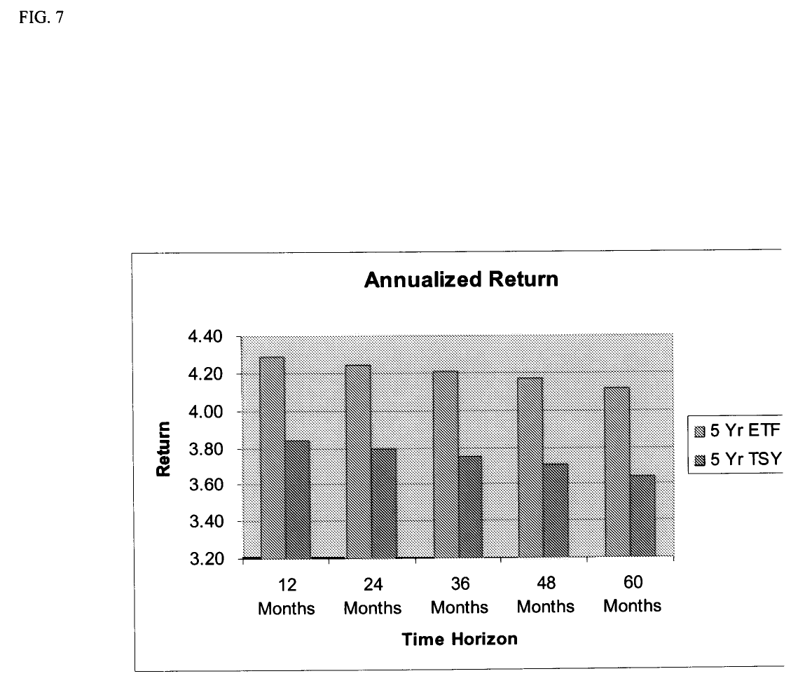

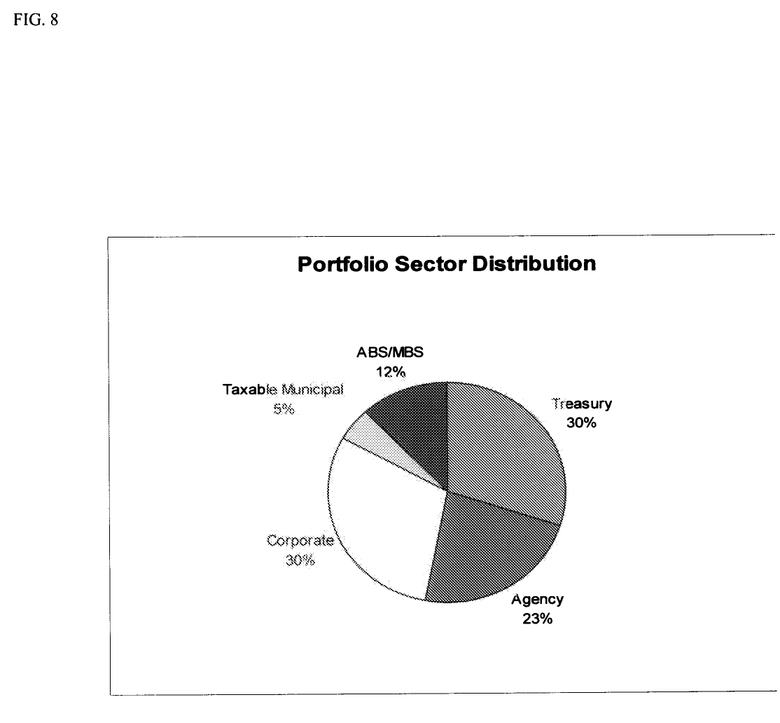

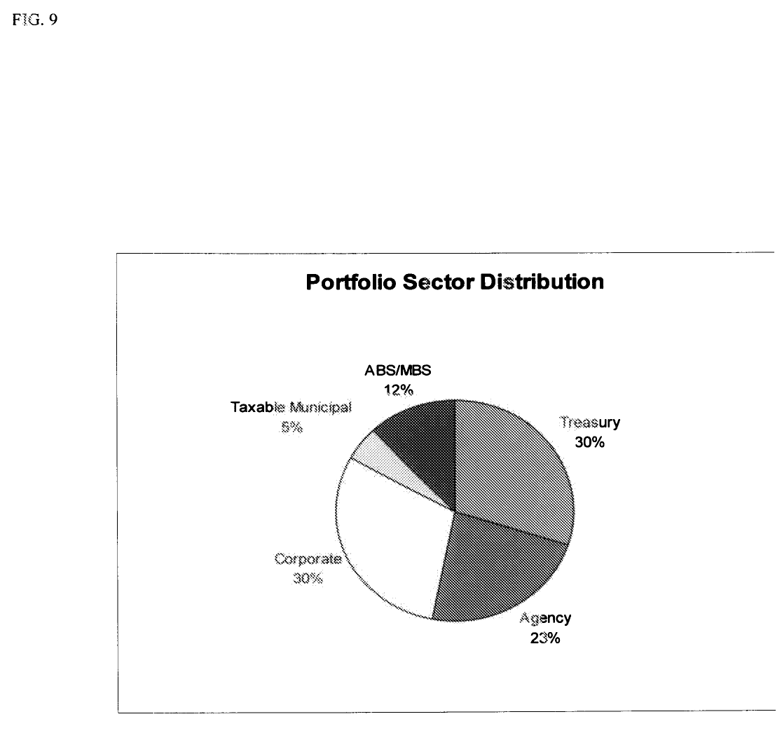

An exemplary roll down the yield curve is shown in FIG. 4. And as can be seen with reference to FIG. 5, and ETF duration according to the invention is closely tied with its benchmark. FIGS. 6-7 show hypothetical annual interest cashflow and return compared to a hypothetical treasury note. FIG. 8 shows a model portfolio sector distribution of an ETF according to the invention. FIG. 9 shows a model portfolio quality distribution of an ETF according to the invention.

An ETF according to the invention need not have all of the features described herein; rather, this document discloses embodiments of the more general invention.

What is claimed is:

1. An exchange traded fund having owners, the fund comprising:
a portfolio of multiple fixed income securities, wherein each of the securities has a value and each of the securities generate interest,
wherein each of the securities has a same maturity, within a defined range;
wherein the securities mature on a same date, within a defined range;
wherein the fund pays the owners an amount of the generated interest at defined intervals; and
wherein, after the securities mature, the fund pays the owners an amount based on the value of the securities.

2. The fund of claim 1, wherein the fund is an open-end index fund.

3. The fund of claim 1, wherein the fund is a unit investment trust.

4. The fund of claim 1, wherein the fund is a grantor trust.

5. The fund of claim 1, wherein the maturity is between 3 and 30 years.

6. The fund of claim 1, wherein the securities comprise fixed-rate coupon bonds.

7. The fund of claim 1, wherein the securities comprise floating-rate bonds, and further comprising an interest rate swap referenced to the maturity.

8. An exchange traded fund comprising:
means for generating income for a predefined period of time, wherein the means comprise a portfolio of interest bearing securities having a common maturity and a common maturity date;
means for distributing income produced from the means for generating income to an owner of the exchanged traded fund at periodic intervals;
means for distributing the principal of the interest bearing securities to an owner of the fund upon maturity.

9. The fund of claim 8, wherein the means for generating income comprise fixed-rate coupon bonds.

10. The fund of claim 9, wherein the securities comprise floating-rate bonds, and further comprising an interest rate swap referenced to the maturity.

11. An investment method comprising the following steps:
purchasing an exchange traded fund comprising multiple fixed income securities, each of the securities having the same maturity within a defined range and maturing on the same date within a defined range;
receiving interest generated from the multiple fixed income securities at periodic intervals;
receiving an amount based on the value of the multiple fixed income securities at maturity, thereby concluding the investment.
